(19) United States
(12) Patent Application Publication
(10) Pub. No.: US 2023/0060236 A1
(43) Pub. Date: Mar. 2, 2023

(54) NOTIFICATION SYSTEM AND NOTIFICATION METHOD

(71) Applicant: TOYOTA JIDOSHA KABUSHIKI KAISHA, Toyota-shi (JP)

(72) Inventors: Hideki FUKUDOME, Toyota-shi (JP); Kosuke AKATSUKA, Mishima-shi (JP); Myu UEHARA, Nisshin-shi (JP); Tsukasa KITO, Aisai-shi (JP); Satoshi OMI, Ebina-shi (JP); Yuki NISHIKAWA, Susono-shi (JP)

(21) Appl. No.: 17/812,781

(22) Filed: Jul. 15, 2022

(30) Foreign Application Priority Data
Aug. 25, 2021 (JP) 2021-137279

(51) Int. Cl. B60W 50/16; G05D 1/00; B60W 30/14; B60W 40/109

(52) U.S. Cl. CPC B60W 50/16; B60W 30/146; B60W 40/109; G05D 1/0011; B60W 2300/12; B60W 2520/125; G05D 2201/0213

(57) ABSTRACT

A notification system includes at least one memory in which a program is stored and at least one processor combined with the at least one memory. The at least one processor is configured to execute, by executing the program, an acquisition process of acquiring at least one physical quantity from among acceleration, lateral acceleration, jerk, and vibration amplitude of a truck bed, and a notification process of sending a notification to a remote driving operator in response to a fact that the physical quantity exceeds a first threshold value set for each type of physical quantity.

### CROSS-REFERENCE TO RELATED APPLICATION

This application claims priority to Japanese Patent Application No. 2021-137279 filed on Aug. 25, 2021, incorporated herein by reference in its entirety.

### BACKGROUND

### 1. Technical Field

The present disclosure relates to a notification system and a notification method for sending a notification to a remote driving operator under a predetermined condition during remote driving of a remote driving vehicle having a truck bed.

### 2. Description of Related Art

In recent years, remote driving technology for remotely driving a vehicle (remote driving vehicle) from a remote location has been considered. Remote driving may be applied to manual driving vehicles or autonomous driving vehicles. In remote driving, there may be an issue in which a remote driving operator finds it difficult to recognize a driving environment and a sense of vehicle because the remote driving operator performs a driving operation without directly boarding a remote driving vehicle. In recent years, a technique for supporting recognition of a driving environment and a sense of vehicle has been disclosed. For example, Japanese Unexamined Patent Application Publication No. 2020-058003 discloses a remote control device (remote driving device) that improves operability by displaying a distance to a surrounding object on a monitor.

### SUMMARY

In the remote driving technology, it is assumed that remote driving is performed for a remote driving vehicle having a truck bed in a state where articles are loaded on the truck bed. In such a case, when the truck bed excessively shakes or vibrates due to the traveling environment of the remote driving vehicle, the loaded article may be damaged. Therefore, the remote driving operator is required to perform a driving operation in consideration of the situation of the truck bed. However, it is difficult for the remote driving operator to recognize the situation of the truck bed.

The present disclosure discloses a notification system and a notification method that allow a remote driving operator to recognize, during remote driving of a remote driving vehicle having a truck bed, that the truck bed is in a situation where it can cause damage to the loaded article.

A first aspect of the present disclosure relates to a notification system that sends a notification to a remote driving operator under a predetermined condition in remote driving of a remote driving vehicle having a truck bed. The notification system includes at least one memory where a program is stored and at least one processor combined with the at least one memory. The at least one processor is configured to execute, by executing the program, an acquisition process of acquiring at least one physical quantity from among acceleration, lateral acceleration, jerk, and vibration amplitude of the truck bed, and a notification process of sending the notification to the remote driving operator in response to the fact that the physical quantity exceeds a first threshold value set for each type of physical quantity.

In the first aspect, in the notification process, the at least one processor may send the notification by causing a steering wheel that accepts a driving operation of the remote driving operator or a seat on which the remote driving operator sits to vibrate.

In the first aspect, the at least one processor may further execute, by executing the program, a vehicle speed limiting process of limiting a vehicle speed of the remote driving vehicle in response to a fact that the physical quantity exceeds a second threshold value set for each type of physical quantity.

In the first aspect, in the vehicle speed limiting process, the at least one processor may limit the vehicle speed by setting an upper limit of the vehicle speed according to a magnitude of the physical quantity.

A second aspect of present disclosure relates to a notification method of sending a notification to a remote driving operator under a predetermined condition during remote driving of a remote driving vehicle having a truck bed. The notification method includes acquiring at least one physical quantity from among acceleration, lateral acceleration, jerk, and vibration amplitude of the truck bed, and sending the notification to the remote driving operator in response to a fact that the physical quantity exceeds a first threshold value set for each type of physical quantity.

In the second aspect, sending the notification may include sending the notification by causing a steering wheel that accepts a driving operation of the remote driving operator or a seat on which the remote driving operator sits to vibrate.

In the second aspect, the notification method may further include limiting a vehicle speed of the remote driving vehicle in response to a fact that the physical quantity exceeds a second threshold value set for each type of physical quantity.

In the second aspect, limiting the vehicle speed may include limiting the vehicle speed by setting an upper limit of the vehicle speed according to a magnitude of the physical quantity.

With the notification system and the notification method according to each aspect of the present disclosure, when at least one physical quantity from among the acceleration, lateral acceleration, jerk, and vibration amplitude of the truck bed exceeds the first threshold value, the remote driving operator is notified thereof. This allows the remote driving operator to recognize that the truck bed is in a situation where it can cause damage to the loaded article.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual view illustrating an example of a remote driving system to which a notification system according to a present embodiment is applied;

FIG. 2 is a conceptual view illustrating an outline of a function provided by the notification system according to the present embodiment;

FIG. 3 is a block diagram illustrating a schematic configuration of the notification system according to the present embodiment; and

FIG. 4 is a flowchart illustrating a notification method realized by the notification system according to the present embodiment.

### DETAILED DESCRIPTION OF EMBODIMENTS

Hereinafter, embodiments of the present disclosure will be described with reference to the drawings. However, when the numbers such as the number, quantity, amount, range, and the like of each element are referred to in an embodiment described below, the ideas of the present disclosure are not limited to the numbers mentioned, except when explicitly stated or when the numbers are clearly specified in principle. In addition, the configurations and the like described in the embodiments described below are not necessarily essential to the idea of the present disclosure, except when explicitly stated or when clearly specified in principle. In each figure, the same or corresponding parts are designated by the same reference numerals and letters, and the duplicated description thereof will be appropriately simplified or omitted.

### 1. Overview

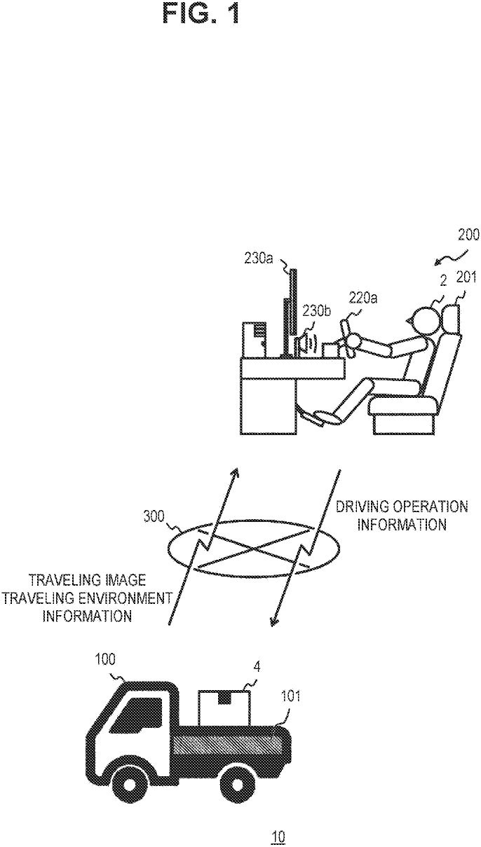

A notification system according to the present embodiment is applied to a remote driving system for remotely driving a remote driving vehicle. FIG. 1 is a conceptual view illustrating an example of a remote driving system 10 to which the notification system according to the present embodiment is applied.

In the remote driving system 10, a remote driving device 200 accepts a driving operation of a remote driving operator 2, and a remote driving vehicle 100 acquires the accepted driving operation. Then, the remote driving vehicle 100 travels according to the driving operation to perform the remote driving.

In the present embodiment, the remote driving device 200 includes at least a steering wheel 220a as a driving operation device that accepts a driving operation. The steering wheel 220a typically accepts driving operations related to steering. The steering wheel 220a may be another operating member that the remote driving operator 2 continuously grips during remote driving. Further, in the present embodiment, the remote driving device 200 includes a seat 201 for the remote driving operator 2 to sit on.

Examples of other driving operation devices include an accelerator pedal that accepts driving operations related to acceleration, a brake pedal that accepts driving operations related to braking, and the like.

In the remote driving system 10, the remote driving device 200 acquires information related to driving such as traveling images and traveling environment information from the remote driving vehicle 100, and provides the information related to driving to the remote driving operator 2. Here, the traveling image, the traveling environment information, and the like are acquired by a camera or a sensor provided in the remote driving vehicle 100 (not illustrated in FIG. 1). Further, the provision of driving information to the remote driving operator 2 is typically performed by an HMI device provided in the remote driving device 200. For example, a traveling image is displayed on a display 230a, and notifications and warnings related to driving are given by a speaker 230b.

Here, the remote driving vehicle 100 and the remote driving device 200 transmit information to each other via a communication network 300. The communication network 300 may be, for example, a mobile communication network in which the remote driving vehicle 100 communicates with the remote driving device 200 by mobile communication via a base station.

In FIG. 1, the remote driving vehicle 100 has a truck bed 101. Further, FIG. 1 illustrates a case where remote driving is performed in a state where a loaded article 4 is loaded on the truck bed 101. For example, FIG. 1 illustrates a case where the loaded article 4 is delivered by remote driving.

In such a case, when the truck bed 101 excessively shakes or vibrates due to the driving environment of the remote driving vehicle 100, the loaded article 4 may be damaged. Therefore, the remote driving operator 2 is required to perform a driving operation in consideration of the situation of the truck bed 101.

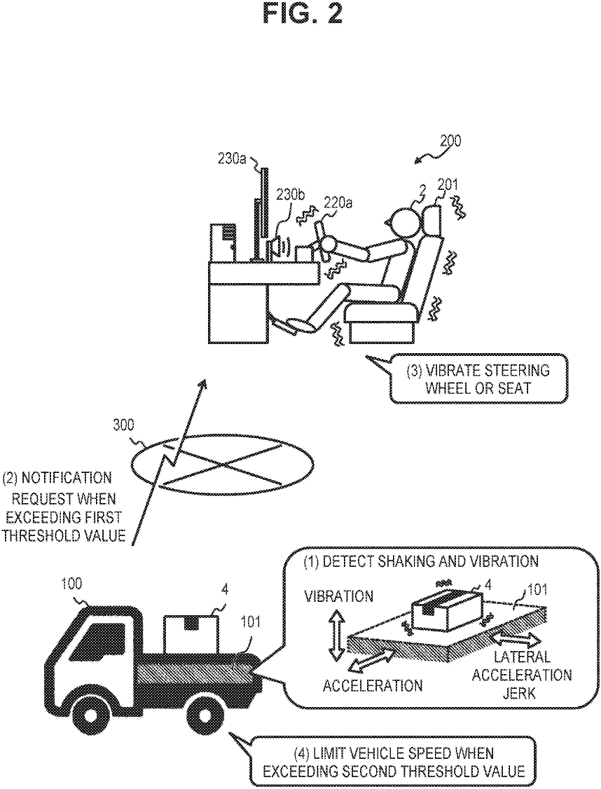

Therefore, a notification system according to the present embodiment provides a function of sending a notification to the remote driving operator 2 when the truck bed 101 is in a situation that may cause the loaded article 4 to be damaged. FIG. 2 is a conceptual view illustrating an outline of the functions provided by the notification system according to the present embodiment.

First, as illustrated in (1) of FIG. 2, the shaking and vibration of the truck bed 101 are detected. In particular, as the detection index of shaking or vibration, at least one physical quantity from among the acceleration, lateral acceleration, jerk, and vibration amplitude of the truck bed 101 is detected and acquired. Here, the information on the jerk may include the change rates of both acceleration and lateral acceleration. The acceleration, lateral acceleration, and jerk of the truck bed 101 are indices related to the shaking of the loaded article 4, and the amplitude of the vibration of the truck bed 101 is an index related to the vibration of the loaded article 4.

Next, as illustrated in (2) of FIG. 2, it is requested that the remote driving operator 2 be notified in response to the fact that the acquired physical quantity exceeds a threshold value (first threshold value). Here, the first threshold value is set for each type of physical quantity. That is, the first threshold value is set for each of the acceleration, lateral acceleration, jerk, and vibration amplitude. The first threshold value is a threshold value which indicates that damage can be caused to the loaded article 4.

Then, as illustrated in (3) of FIG. 2, the remote driving device 200 notifies the remote driving operator 2. As a result, the remote driving operator 2 can recognize that the truck bed 101 is in a situation where it can cause damage to the loaded article 4. FIG. 2 illustrates a case where the notification is performed by applying vibration to the steering wheel 220a or the seat 201. By performing the notification in this way, it is possible to perform the notification such that the remote driving operator 2 can definitely recognize it. Further, as a notification, a display on the display 230a or a warning by the speaker 230b may be performed.

Further, as illustrated in (4) of FIG. 2, the notification system according to the present embodiment limits the vehicle speed of the remote driving vehicle 100 in response to the fact that the acquired physical quantity exceeds a threshold value (second threshold value). As a result, it is possible to reduce the shaking and vibration of the truck bed 101 without requiring a driving operation by the remote driving operator 2. As a result, it is possible to prevent damage to the loaded article 4. Here, the second threshold value is set for each type of physical quantity in the same manner as the first threshold value. In particular, the second threshold value may be the same as the first threshold value. Further, the vehicle speed is limited by setting an upper limit of the vehicle speed according to the magnitude of the physical quantity to be acquired. As a result, the vehicle speed can be limited according to the degree of the influence on the loaded article 4.

### 2. Notification System

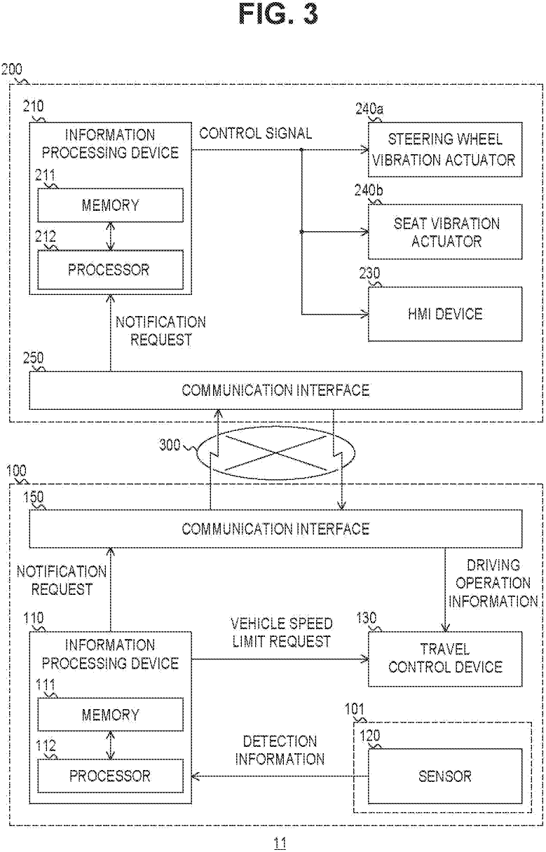

Hereinafter, the notification system according to the present embodiment will be described. The notification system according to the present embodiment notifies the remote driving operator 2 under predetermined conditions. FIG. 3 is a block diagram illustrating a schematic configuration of a notification system 11 according to the present embodiment. Hereinafter, each component of the notification system 11 according to the present embodiment will be described with reference to FIG. 3.

A sensor 120 is provided in the truck bed 101 of the remote driving vehicle 100, detects at least one physical quantity from among the acceleration, lateral acceleration, jerk, and vibration amplitude of the truck bed 101, and outputs detection information. As the sensor 120, a suitable known acceleration sensor, vibration sensor, or a combination thereof may be adopted. The detection information output by the sensor 120 is transmitted to an information processing device 110.

The detection information output by the sensor 120 may be not only the information directly detected but also information obtained by arithmetic processing. For example, the information on the jerk may be information obtained by arithmetic processing based on the directly detected acceleration or lateral acceleration information. In this case, the sensor 120 may be configured to include a processor that performs arithmetic processing.

The information processing device 110 is a computer including a memory 111 and a processor 112 combined with the memory 111. The information processing device 110 is typically one of electronic control units (ECUs) provided in the remote driving vehicle 100. However, the information processing device 110 may be a device provided outside the remote driving vehicle 100. For example, the information processing device 110 may be a server configured in the communication network 300.

The memory 111 stores various data and a program that can be executed by the processor 112. The information (including at least the detection information acquired from the sensor 120) acquired by the information processing device 110 is stored in the memory 111. The processor 112 reads data and a program from the memory 111, and executes a process according to the program based on the data.

The processing executed by the processor 112 in the information processing device 110 includes a notification process for outputting a notification request in response to the fact that the acquired physical quantity acquired as detection information exceeds the first threshold value, and a vehicle speed limiting process for outputting a vehicle speed limit request (vehicle speed limit request) in response to the fact that the acquired physical quantity as detection information exceeds the second threshold value. Here, the vehicle speed limit request includes information that sets an upper limit of the vehicle speed. The notification request is transmitted to the remote driving device 200 via the communication network 300, and the vehicle speed limit request is transmitted to a travel control device 130.

The travel control device 130 is a device that acquires driving operation information from the remote driving device 200 via the communication network 300 and executes a process related to the traveling control (acceleration control, braking control, steering control, and the like) of the remote driving vehicle 100 according to the driving operation information. Remote driving is realized by controlling the traveling of the remote driving vehicle 100 according to the driving operation information by the travel control device 130.

The driving operation information is output by a driving operation device (not illustrated in FIG. 3) provided in the remote driving device 200 and transmitted to the travel control device 130 via the communication network 300.

The travel control device 130 may be composed of, for example, a plurality of ECUs respectively corresponding to each of the actuators provided in the remote driving vehicle 100 or for each group of the actuators. Examples of the actuator included in the remote driving vehicle 100 include an actuator for driving a power unit, an actuator for driving a brake mechanism, an actuator for driving a steering mechanism, and the like.

While receiving the vehicle speed limit request (including information that sets the upper limit of vehicle speed) from the information processing device 110, the travel control device 130 executes travel control such that the vehicle speed of the remote driving vehicle 100 is limited to the upper limit or less according to the vehicle speed limit request. As a result, the vehicle speed limit of the remote driving vehicle 100 is realized. The travel control device 130 may be configured to perform a gradual change process such that the vehicle speed of the remote driving vehicle 100 does not suddenly change in the travel control that limits the vehicle speed.

A communication interface 150 is provided in the remote driving vehicle 100, and is a device that provides an interface capable of transmitting and receiving information to and from the remote driving device 200 via the communication network 300. The communication interface 150 may be, for example, a communication device that wirelessly communicates with a base station located around the remote driving vehicle 100.

A communication interface 250 is provided in the remote driving device 200, and is a device that provides an interface capable of transmitting and receiving information to and from the remote driving vehicle 100 via the communication network 300. The communication interface 250 may be, for example, a communication device that connects to the Internet and transmits and receives information.

The information processing device 210 is a computer including a memory 211 and a processor 212 combined with the memory 211. Various data and a program that can be executed by the processor 212 are stored in the memory 211. The information acquired by the information processing device 210 is stored in the memory 211. The processor 212 reads data and a program from the memory 211, and executes a process according to the program based on the data.

When the information processing device 210 receives a notification request from the remote driving vehicle 100 by the process executed by the processor 212, the information processing device 210 outputs a control signal for a notification to a steering wheel vibration actuator 240a, a seat vibration actuator 240b, and an HMI device 230. Then, the steering wheel vibration actuator 240a, the seat vibration actuator 240b, and the HMI device 230 operate according to the control signal, such that the remote driving operator 2 is notified.

The steering wheel vibration actuator 240a operates so as to cause the steering wheel 220a to vibrate according to a control signal. The seat vibration actuator 240b operates so as to cause the seat 201 to vibrate according to a control signal. Suitable known techniques may be adopted for the mechanism and control signal of the actuator for applying vibration.

The HMI device 230 operates so as to send a notification to the remote driving operator 2 according to a control signal. For example, the display 230a makes a specific display according to a control signal. Alternatively, the speaker 230b issues a specific warning according to a control signal.

The information processing device 210 may be configured to execute other processing. For example, a process of displaying a traveling image acquired from the remote driving vehicle 100 on the display 230a may be executed.

By configuring the notification system 11 in this way, the functions described in FIG. 2 can be realized. However, the information processing device 210 may be configured to execute the notification process and the vehicle speed limiting process. In this case, the information processing device 210 is configured to acquire detection information from the sensor 120 via the communication network 300. Further, the travel control device 130 is configured to acquire a vehicle speed limit request from the information processing device via the communication network 300.

### 3. Notification Method

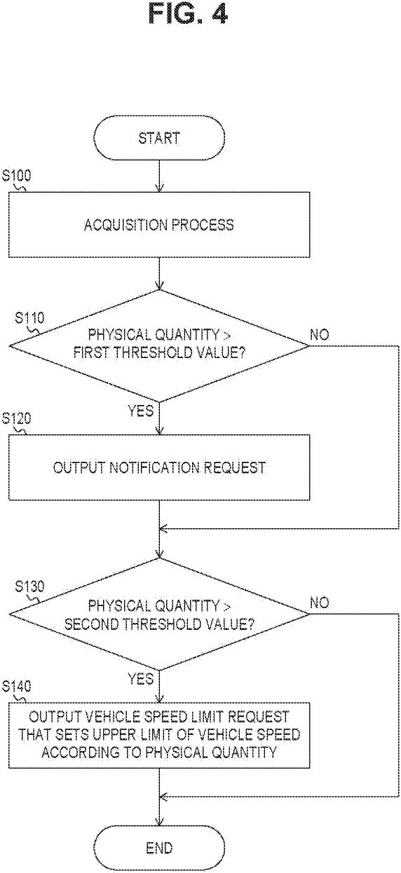

Hereinafter, a notification method realized by the notification system 11 according to the present embodiment will be described. FIG. 4 is a flowchart illustrating the notification method realized by the notification system 11 according to the present embodiment. The process illustrated in FIG. 4 is executed at predetermined intervals.

In step S100 (acquisition process), the information processing device 110 acquires at least one physical quantity from among acceleration, lateral acceleration, jerk, and vibration amplitude as detection information from the sensor 120.

After step S100, the process proceeds to step S110.

In step S110, the processor 112 determines whether the physical quantity acquired in step S100 exceeds the first threshold value. Here, the first threshold value may be suitably set according to the environment to which the notification system 11 according to the present embodiment is applied. For example, the first threshold value may be experimentally set so as to be optimal through the vehicle compatibility of the remote driving vehicle 100. Further, the first threshold value is set for each type of physical quantity (acceleration, lateral acceleration, jerk, or vibration amplitude), and it is determined whether the first threshold value is exceeded for each physical quantity.

When any of the physical quantities exceed the first threshold value (step S110; Yes), the process proceeds to step S120. When none of the physical quantities exceed the first threshold value (step S110; No), the process proceeds to step S130.

In step S120 (notification process), the information processing device 110 outputs a notification request in response to the fact that the physical quantity exceeds the first threshold value. Then, the information processing device 210 receives the notification request and outputs a control signal to perform notification (by vibration of the steering wheel 220a, vibration of the seat 201, and the HMI device 230).

After step S120, the process proceeds to step S130.

In step S130, the processor 112 determines whether the physical quantity acquired in step S100 exceeds the second threshold value. Here, the second threshold value may be suitably set according to the environment to which the notification system 11 according to the present embodiment is applied. Further, the second threshold value is set for each type of physical quantity (acceleration, lateral acceleration, jerk, or vibration amplitude), and it is determined whether the second threshold value is exceeded for each physical quantity.

When any of the physical quantities exceed the second threshold value (step S130; Yes), the process proceeds to step S140. When none of the physical quantities exceed the second threshold value (step S130; No), the process ends.

In step S140 (vehicle speed limiting process), the information processing device 110 outputs a vehicle speed limit request (including information that sets an upper limit of the vehicle speed) in response to the fact that the physical quantity exceeds the second threshold value. Then, the travel control device 130 executes the travel control such that the vehicle speed of the remote driving vehicle 100 is limited to the upper limit or less according to the vehicle speed limit request. Here, the upper limit of the vehicle speed is set according to the magnitude of the physical quantity exceeding the second threshold value. For example, it is configured to set an upper limit that is inversely proportional to the magnitude of the physical quantity. However, the method of giving the upper limit may be appropriately set according to the environment to which the notification system according to the present embodiment is applied. Further, when a plurality of physical quantities exceed the second threshold value, the smallest upper limit set according to the magnitude of each physical quantity may be adopted.

After step S140, the process ends.

The first threshold value and the second threshold value may be the same. In this case, the process illustrated in step S130 in FIG. 4 is not required, and the process according to step S140 is executed after the process according to step S120 or in parallel with the process according to step S120 when any of the physical quantities exceed the first threshold value (second threshold value) (step S110; Yes).

### 4. Effects

As described above, according to the notification system and the notification method according to the present embodiment, when at least one physical quantity from among the acceleration, lateral acceleration, jerk, and vibration amplitude of the truck bed 101 exceeds the first threshold value, the remote driving operator 2 is notified. As a result, the remote driving operator 2 can recognize that the truck bed 101 is in a situation that may cause the loaded article 4 to be damaged. Further, the notification may be performed by applying vibration to the steering wheel 220a or the seat 201. As a result, the remote driving operator 2 can be notified such that the notification can be reliably recognized.

Further, according to the notification system and the notification method according to the present embodiment, when the physical quantity of at least one from among the acceleration, lateral acceleration, jerk, and vibration amplitude of the truck bed 101 exceeds the second threshold value, the vehicle speed of the remote driving vehicle 100 is limited. As a result, it is possible to reduce the shaking and vibration of the truck bed 101 without requiring a driving operation by the remote driving operator 2. As a result, it is possible to prevent damage to the loaded article 4.

Further, the vehicle speed is limited by giving an upper limit of the vehicle speed according to the magnitude of the physical quantity to be acquired. As a result, the vehicle speed can be limited according to the degree of the influence on the loaded article 4.

In the application of the notification system 11 according to the present embodiment, the remote driving vehicle 100 having the truck bed 101 is not limited to a freight vehicle. For example, a van having a vehicle body in which a seat and a truck bed 101 are integrally configured, or a two-wheeled vehicle having a truck bed 101 may be used.

Further, the function provided by the notification system 11 according to the present embodiment may be configured such that it can be turned on and off as appropriate by operating the HMI device 230 or the like. As a result, it is possible to prevent the notification from being performed in an unnecessary situation such as when the truck bed 101 does not have the loaded article 4.

What is claimed is:

1. A notification system that sends a notification to a remote driving operator under a predetermined condition during remote driving of a remote driving vehicle having a truck bed, the notification system comprising:
at least one memory where a program is stored; and
at least one processor combined with the at least one memory,
wherein the at least one processor is configured to execute, by executing the program,
an acquisition process of acquiring at least one physical quantity from among acceleration, lateral acceleration, jerk, and vibration amplitude of the truck bed, and
a notification process of sending the notification to the remote driving operator in response to a fact that the physical quantity exceeds a first threshold value set for each type of physical quantity.

2. The notification system according to claim 1, wherein the at least one processor is configured to, in the notification process, send the notification by causing a steering wheel that accepts a driving operation of the remote driving operator or a seat on which the remote driving operator sits to vibrate.

3. The notification system according to claim 1, wherein the at least one processor is configured to further execute, by executing the program, a vehicle speed limiting process of limiting a vehicle speed of the remote driving vehicle in response to a fact that the physical quantity exceeds a second threshold value set for each type of physical quantity.

4. The notification system according to claim 3, wherein the at least one processor is configured to, in the vehicle speed limiting process, limit the vehicle speed by setting an upper limit of the vehicle speed according to a magnitude of the physical quantity.

5. A notification method of sending a notification to a remote driving operator under a predetermined condition during remote driving of a remote driving vehicle having a truck bed, the notification method comprising:
acquiring at least one physical quantity from among acceleration, lateral acceleration, jerk, and vibration amplitude of the truck bed, and
sending the notification to the remote driving operator in response to a fact that the physical quantity exceeds a first threshold value set for each type of physical quantity.

6. The notification method according to claim 5, wherein sending the notification includes sending the notification by causing a steering wheel that accepts a driving operation of the remote driving operator or a seat on which the remote driving operator sits to vibrate.

7. The notification method according to claim 5, further comprising limiting a vehicle speed of the remote driving vehicle in response to a fact that the physical quantity exceeds a second threshold value set for each type of physical quantity.

8. The notification method according to claim 7, wherein limiting the vehicle speed includes limiting the vehicle speed by setting an upper limit of the vehicle speed according to a magnitude of the physical quantity.
